(19) United States
(12) Patent Application Publication
(10) Pub. No.: US 2005/0243326 A1
(43) Pub. Date: Nov. 3, 2005

(54) Imaginary polarizing measuring method for simultaneously measuring the optical crystal thickness and the optic axis direction

(76) Inventors: Jung Y. Huang, Hsinchu City (TW); Chien-Li Lee, Ji-an Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/862,389

(22) Filed: Jun. 8, 2004

(30) Foreign Application Priority Data
Apr. 30, 2004 (TW) 93112173

(51) Int. Cl. G01B 9/02

(52) U.S. Cl. 356/492

(57) ABSTRACT

The present invention provides an imaginary optical measuring method that can simultaneously obtain both the thickness of optical crystals and the optic axis direction. The method utilizes a same polarimetry system to perform the rotating measurement of the analyzer. Some images of light intensity variation corresponding to different azimuth positions of the analyzer are obtained, and these images are performed a curve-fitting process to get the projected optic axis direction that the optic axis projecting on the specimen plane. Next, the rotating measurement of the specimen is performed to continuously adjust incident angles of the polarized light, and the optic axis direction in 3-dimentional space and the 2-dimentional distribution of the thickness are measured. Hence, the present invention can obtain both the thickness of optical crystals and the optic axis direction with only one measurement structure, and effects of low-cost, economy, convenient measurement, and accuracy are achieved.

### BACKGROUND OF INVENTION

1. Field of the Invention

The invention relates to a measuring technology of optical crystal, and more particularly, to an imaginary polarizing measuring method that can simultaneously measure the optical crystal thickness and the optic axis direction.

2. Description of the Prior Art

In recent years, the application of the optical crystal film is more and more popular, and for example, the display function of the LCD is close to anisotropism of the LCD optical film. As regards the LCD, the measurement of the thickness and the optic axis direction of the LCD film is very important. The polarimetry is important equipment for researching anisotropism of the film. The optical measurement of thickness, retardation or optic axis pretilt angle of the uniaxial crystal film all show the polarimetry has very important application. However, there is no polarimetric system that can simultaneously measure the optical crystal thickness and the optic axis direction at present.

The first conventional polarimetric system obtains the birefringence distribution of the film and the projected angle on film plane of the optic axis with rotating an analyzer, but the system cannot further get the film thickness and the pretilt angle distribution.

The second conventional polarimetry system obtains the optic axis pretilt angle with rotating the specimen. When the specimen is rotated to a specific angle, the light just goes forward the optic axis or its vertical direction after being refracted, and the optic axis pretilt angle can be reasoned with the angle of the polar value of the transmission rate. But this method can only measure the pretilt angle which ranges between 0°˜20° or 70°˜90°, and that also means only the very small or very large pretilt angles can be measured. The film thickness cannot be obtained.

The third method can extend the pretilt angle measuring range of the specimen rotation method to 20°-70°. When changing the rotation angle of the specimen, a periodic light-and-shade variation of the transmission light intensity is happened, and the optic axis pretilt angle factor can be inferred with two adjacent maximum (brightest) and minimum (darkest) rotation angles. However, this method isn't suitable for specimens thicker than 20 μm, since the thick specimens cannot be found two maximum and minimum values corresponding to the transmission intensities. This method can improve the limitation of the measuring range of the optic axis pretilt angle, but not the thickness factor. This method is only suitable for the measurement of the optic axis pretilt angle with laser striking, and that also means this method only measures single point and cannot be extended to 2-dimentional distribution of the optic axis pretilt angle measurement.

The fourth method is fixing the specimen. This method condenses the light to the specimen with the lens, and the pretilt angle factor can be obtained with observing the shift of the interference center of the transmission light on the screen. The drawback of this method is a large numerical aperture lens is required, and only the pretilt angle at the focus can be measured. The pretilt angle range of this method is 0°-20° or 70°-90°, and the thickness factor is lost.

The fifth measuring method is utilizing an ellipsometery. With changing angles of the polarizer and the analyzer, the intensity of the transmission spectrum can be zero at a specific wavelength (null transmission), and the twist angle and the retardation of the liquid crystal specimen can be obtained. When the specimen is thick (<3 μm), the measured spectrum curve will become wide, so the wavelength corresponding to the null transmission cannot be correctly found and the thick specimen cannot be measured. Furthermore, the measured retardation is coupled with two factors, thickness and pretilt angle, so one of these two factors should be known in advance to get the other. In addition, this method utilizes the spectrometer and is only suitable for single point measurement.

The sixth method is also using an ellipsometery. With measuring the total intensity ratio between any two spectrums, the thickness of the specimen can be obtained. This method assumes the inaccuracy can be omitted under small optic axis pretilt angle, so another method is required to obtain factors of the optic axis pretilt angle in advance when the pretilt angle is large. In addition, this method also utilizes the spectrometer and is only suitable for single point measurement.

The conventional polarimetry measurement equipment can only measure the thickness or the optic axis, and cannot measure both of them at the same time. Most systems are only suitable for single point measurement, and if different factors are needed, many different systems are required. Hence, a measurement structure that can obtain the thickness of specimens and the 2-dimentional distribution of optic axis pretilt angle is required.

### SUMMARY OF INVENTION

It is therefore a primary objective of the claimed invention to provide an imaginary optical measuring method that can obtain both the thickness of optical crystals and the optic axis direction with only one measurement structure.

It is therefore another objective of the claimed invention to provide an imaginary polarizing measuring method that can simultaneously measure the film thickness and the optic axis direction to improve the drawbacks of using many measurement structures, effectively reduce the cost of optical measurement, and provide a economic and convenient measuring method.

It is therefore a further objective of the claimed invention to overcome the disadvantages of limited and unreal factors of the conventional measuring system. The image compensating process is accomplished with the interpolation and the curve fitting to recover the image to normal size, and a series of images are correctly overlapped to provide the accurate optical measurement value.

According to the claimed invention, an imaginary polarizing measuring method for simultaneously measuring an optical crystal thickness and an optic axis direction is achieved with a same polarimetry system. The polarimetry system includes a polarizing apparatus, a specimen stage, an analyzer and an image detecting apparatus. A specimen is located on the specimen stage. The measuring method includes steps of rotating the analyzer while a polarized light from the polarizing apparatus passing through the specimen to the analyzer, a plurality of images of a light intensity variation corresponding to different azimuth positions of the analyzer are obtained. A projected optic axis direction, the optic axis of the specimen projecting on a specimen plane, is decided according to fitting of the images. Then, rotating the specimen for adjusting an incident angle of the polarized light for the specimen to obtain a plurality of different transmission intensities. An optic axis direction and a thickness of the specimen are decided according to detected variation of the transmission intensities.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a system structure according to the present invention.

FIG. 2 is a schematic diagram showing the polarizing measurement principle according to the present invention.

FIG. 3 is a schematic diagram of a crystal rotating coordinate axis and a light path according to the present invention.

FIG. 4a is a 2-dimentional distribution of the optic axis projecting on the crystal plane according to the present invention.

FIG. 4b is a 3-dimentional diagram of the specimen thickness, the analyzer rotating angle, and the optical transmittance while the optic axis pretilt angle is zero.

FIG. 4c is a comparison diagram of reducing with a linear interpolation according to the present invention.

FIG. 4d is a diagram of the experiment data, the light intensity and the rotating angle, curve-fitted with the theory.

FIG. 4e is a 2-dimentional distribution of the crystal thickness and the optic axis pretilt angle according to the present invention.

FIG. 5a is a theoretical optical transmittance diagram of the specimen thickness and the analyzer rotating angle when the optic axis pretilt angle is 50°.

FIG. 5b is a theoretical diagram of the specimen rotating angle and the retardation when the thickness is 4.9 μM and the pretilt angle is 50 degrees.

FIG. 5c is a curve-fitting diagram of the experiment data and the theory of the light intensity when rotating the liquid crystal specimen.

FIG. 5d is a 2-dimentional distribution of the pretilt angle and the thickness according to the present invention.

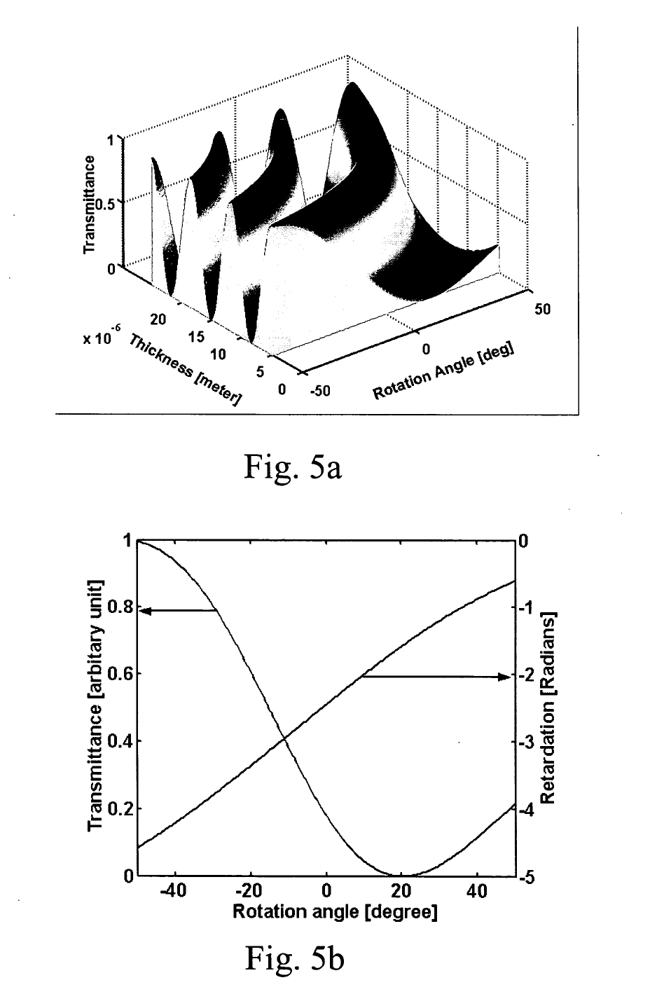

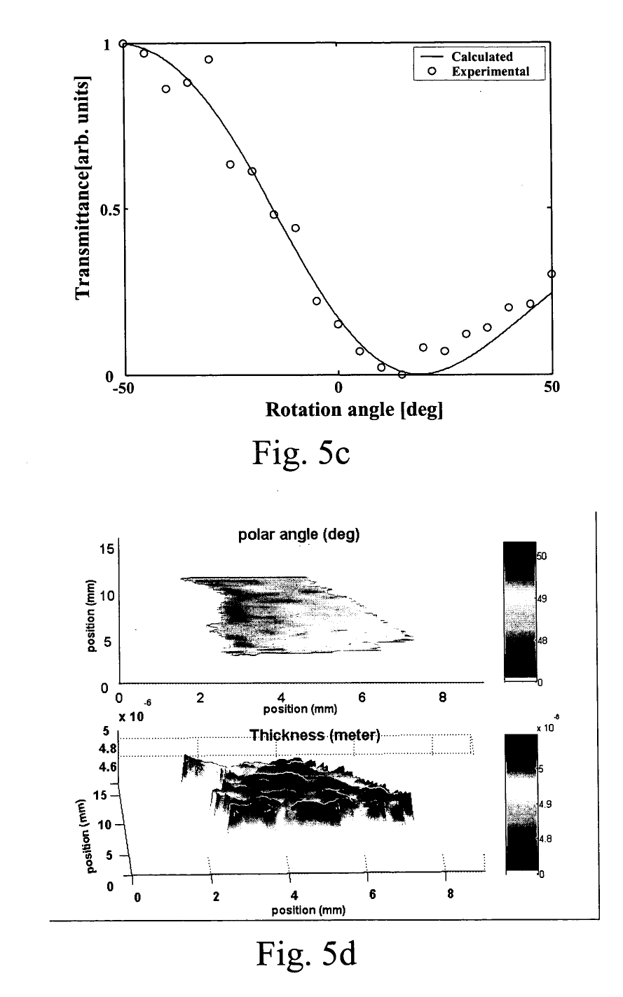

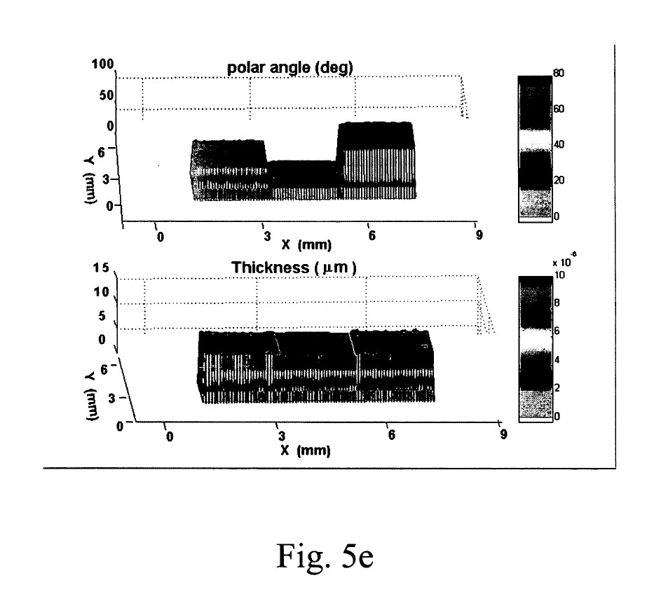

FIG. 5e is a 2-dimentional distribution of the pretilt angle (upper) and the thickness (lower) of the liquid crystal spatial light modulator.
10 polarizing apparatus
102 light source
104 beam expander
106 polarizer
108 quarter-wave plate
12 specimen
14 analyzer
16 image detecting apparatus
162 lens
164 charge coupled device

### DETAILED DESCRIPTION

The present invention utilizes a polarimetry system to perform the rotating measurement of the analyzer, and the 2-dimentional distribution of the optic axis of the specimen projecting on a specimen plane can be obtained. Next, the specimen is rotated to measure, and the 3-dimentional direction of optic axis and the 2-dimentional distribution of thickness of the specimen can be confirmed.

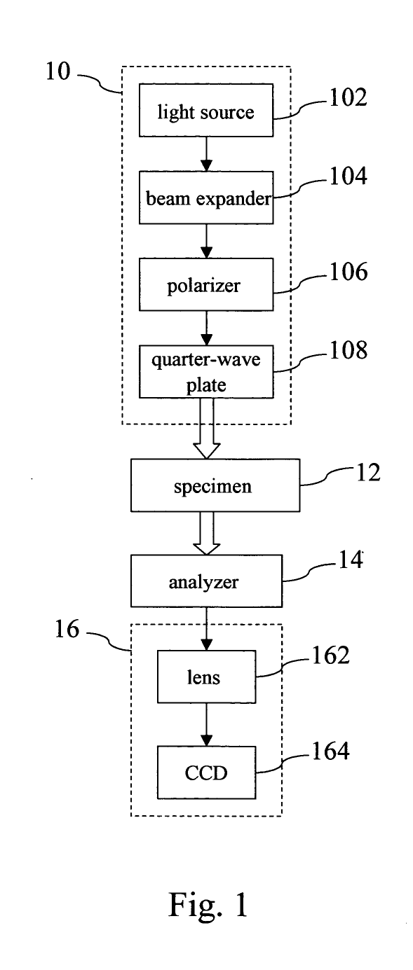

FIG. 1 is a schematic diagram of a system structure according to the present invention. The polarimetry system includes a polarizing apparatus 10, a specimen stage, an analyzer 14 and an image detecting apparatus 16. A specimen 12, which is a uniaxial crystal film, is located on the specimen stage. The polarizing apparatus 10 includes a light source 102, which is a He—Ne laser with wavelength 632 nm. The light beam expands to a light with uniform intensity via a 40-times beam expander 104, and becomes a right-circularly polarized light of the round polarized light via a polarizer 106 and a quarter-wave plate 108. The analyzer 14 is generally a polarizer that transmits the polarized light passing through the specimen 12 to the variation diagram of the light intensity for analyzing the polarization state of the polarized light passing through the specimen 12. The image detecting apparatus 16 includes a lens 162 and a charge coupled device (CCD) 164. After the polarizing apparatus 10 produces a dextrorotatory light, the dextrorotatory light is injected into the specimen 12. The emitting light passes through the analyzer 14 included φ by a transmission axis and an x-axis, and the transmission image is magnified to image onto the CCD 164 via the lens 162 according to requirement.

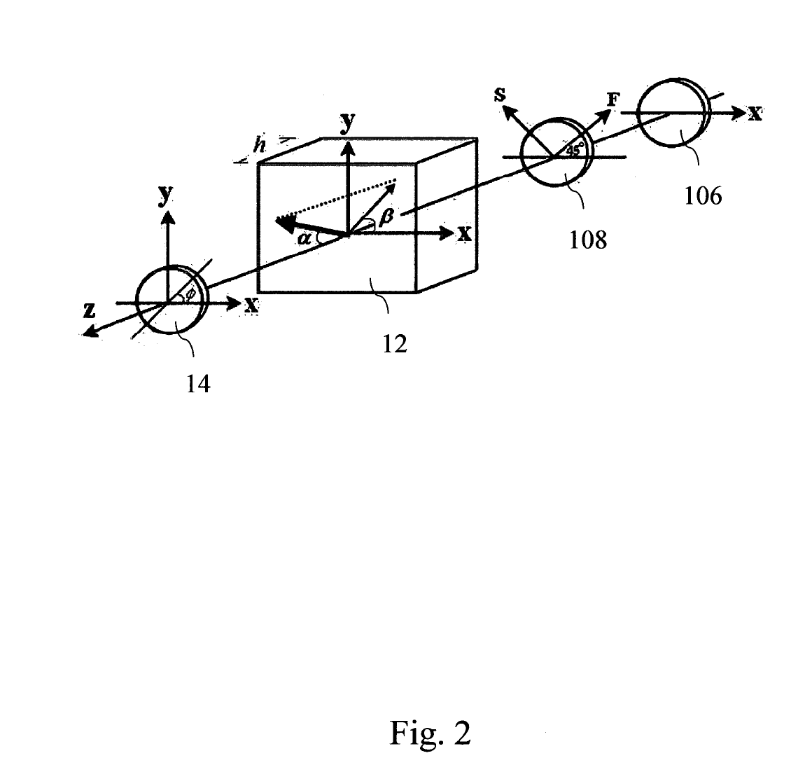

For understanding the function of the polarizing system and its devices, FIG. 2, a schematic diagram showing the polarizing measurement principle, is used for explaining the present invention. The specimen plane is defined as x-y plane, and the direction pretilt angle of the optic axis of the specimen in the 3-dimentional space is defined as a included angle α between the optic axis and the z-axis. When the optic axis is projected on the x-y plane, the angle include with the x-axis is β.

The imaginary polarizing measuring method includes step of: firstly, rotating the analyzer 14 to make the analyzer 14 continuously varying different azimuth φ positions. When the right-circularly polarized light produced by passing through the polarizer 106 and the quarter-wave plate 108 passes the specimen 12 to the analyzer 14, a plurality of different images of the light intensity variation corresponding to different azimuth φ positions of the analyzer 14 are obtained. Three factors, intensity of incident light, retardation, and projection angle, are used for curve fitting the light intensity variation of the series of images corresponding to a same pixel, and the projected optic axis direction that the optic axis of the specimen projecting on the specimen plane is decided. Wherein, the projected optic axis direction is a direction that the optic axis of the specimen 12 projecting on the specimen plane. The 2-dimentional distribution of the optic axis of the specimen projected on the specimen x-y plane is obtained with measuring the projected angle β of the optic axis of the specimen 12 projected on the specimen x-y plane.

Next, rotating the specimen 12 for continuously adjusting the incident angle of the polarized light for the specimen 12 to obtain a plurality of different transmission intensities, and capturing the corresponding images according to each incident angle. The optic axis direction and the thickness of the specimen are decided according to detected variation of the transmission intensities. In other words, this step decides the direction of the optic axis and the 2-dimentional distribution of the specimen 12 in 3-dimentional space, and decides the 2-dimentional distribution of the thickness h of the specimen 12.

A computer is used in the mentioned polarizing system to control rotation of the analyzer 14 and incident angle adjustment of the polarizing light.

In addition, if the specimen 12 is thicker, the specimen 12 will have the image shift or the size reducing caused by the different incident angles of the polarizing light. For the thick specimen, in the step of deciding the optic axis direction and the thickness of the specimen 12 can further add an image compensating process to compensate the image shift or the size reducing caused by rotation of the specimen 12. The image compensating process reduces the minified image with a linear interpolation after obtaining different transmission intensities to remove the pixel shift effect caused by rotation of the specimen 12. After reducing with the linear interpolation, a curve-fitting process, that analyzes with two factors, thickness and optic axis pretilt angle, is performed to proceed the light intensity variation on pixels. After curve fitting a plurality of pixels, the 2-dimentional distribution diagram of the thickness h and the optic axis pretilt angle α of the specimen 12 are obtained. Then, the image shift or the size reducing caused by the different incident angles of the polarizing light can be compensated and return to original size, and the different images can be correctly overlapped pixel-by-pixel.

According to the above, the principle of the imaginary optical measuring method is distinctly explained, and a concrete ratiocination is described below to prove the present invention. Those of ordinary skill in the art can follow the detailed description to perform.

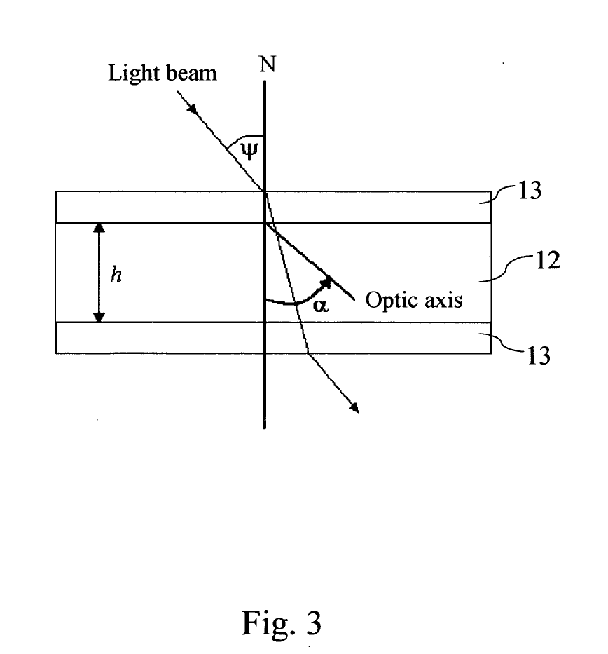

Please refer to FIGS. 2 and 3, the outputting intensity of the polarizing system can be obtained from Jones matrix:

$$\begin{matrix}[ \begin{matrix}{x}^{′} \\ {y}^{′}\end{matrix} ] = [ \begin{matrix}{cos}^{2} ϕ & sin ϕ cos ϕ \\ sin ϕ cos ϕ & {sin}^{2} ϕ\end{matrix} ] [ \begin{matrix}a & b \\ b & c\end{matrix} ] \frac{1}{\sqrt{2}} [ \begin{matrix}1 & i \\ i & 1\end{matrix} ] [ \begin{matrix}1 \\ 0\end{matrix} ] \\ wherein \\ a = d = {cos}^{2} β {ⅇ}^{ⅈ δ / 2} + {sin}^{2} β {ⅇ}^{- ⅈ δ / 2} , \\ b = ⅈ sin 2 β sin ( δ / 2 ) , \\ c = {cos}^{2} β {ⅇ}^{- ⅈ δ / 2} + {sin}^{2} β {ⅇ}^{ⅈ δ / 2} .\end{matrix}$$

With the straight incident angle, namely the crystal specimen 12 isn't rotated, ψ=0, the retardation δ of the transmission light can be shown as:

$$δ ( α ) = ( \frac{2 π}{λ} ) \cdot h \cdot ( \frac{1}{\sqrt{\frac{1}{{n}_{e}^{2}} {sin}^{2} α + \frac{1}{{n}_{o}^{2}} {cos}^{2} α}} - {n}_{o} ) \qquad ( 1 )$$

Wherein, λ is the wavelength of incident light, and h is the specimen thickness.

The intensity of outputting light can be obtained from sum of square of the outputting light field:

$$I = {x}^{′} {x}^{′ *} + {y}^{′} {y}^{′ *} = \frac{{I}_{0}}{2} \{ 1 + sin 2 ( ϕ - β ) sin δ \} , \qquad ( 2 )$$

Herein, I₀ is the intensity of incident light, and sin δ is a constant.

The angle β that the optic axis projected on the x-y plane can be obtained from angle φ while rotating the analyzer 14. For example, the angle φ is rotated from 0° to 180° and takes pictures with the CCD 164 every 10°, 19 pictures can be obtained. In the 19 pictures, 19 intensities corresponding to a same pixel is performed a curve-fitting process of three factors,

$$\frac{{I}_{0}}{2} ,$$

sin δ, and angle β, with the equation (2), and the angle β of the optic axis can be obtained.

After confirming the angle β, for measuring pretilt angle α of the optic axis and thickness of the specimen, the present invention makes sin 2(φ−β)=1 of the equation (2) (or φ−β=π/4) with fixing φ, and the specimen 12 is rotated with a axis along the x-axis and passing through center of the specimen 12. The included angle between the incident light and a normal direction of the specimen 12 is ψ, as shown in FIG. 3, which is a schematic diagram of a crystal rotating coordinate axis and a light path illustrating with the liquid crystal cell. A specimen 12 is clamped in two glass substrates 13. The pretilt angle of the specimen 12 is defined as the included angle α between the optic axis and the normal N of the specimen 12. When the light emitting the specimen 12, the retardation is:

$$δ ( γ , ψ ) = ( \frac{2 π}{λ} ) \cdot h \cdot f ( γ , ψ ) \qquad ( 3 )$$

wherein, γ=π/2−α, and f(γ,ψ) is shown as:

$$f ( γ , ψ ) = \frac{1}{{c}^{2}} ( {a}^{2} - {b}^{2} ) sin γ cos γ sin ψ + \frac{1}{c} {( 1 - \frac{{a}^{2} {b}^{2}}{{c}^{2}} \cdot {sin}^{2} ψ )}^{1 / 2} - \frac{1}{b} {( 1 - {b}^{2} {sin}^{2} ψ )}^{1 / 2} \\ \begin{matrix}a = \frac{1}{{n}_{1}} , & b = \frac{1}{{n}_{2}} , & {c}^{2} = {a}^{2} {cos}^{2} γ + {b}^{2} {sin}^{2} γ ,\end{matrix} \qquad ( 4 )$$

wherein n1 and n2 are individually the refractive indexes of the extraordinary light and the ordinary light.

When the pretilt angle α is fixed, γ is also fixed, so equation (2) can be rewrite as the optical transmittance:

$$T ( ψ ) = \frac{1}{2} \cdot ( 1 + sin δ ( ψ ) ) \qquad ( 5 )$$

With equation (5), the optical transmittance varies according to the rotating angle of the crystal specimen 12, and this variation is decided by two factors of equation (3), α and h. After getting the experiment curve described in equation (5), it is further performed a curve-fitting process with α and h to obtain the pretilt angle of the optic axis and the thickness of the specimen 12.

For each pixel, the intensity variation is a function of the incident angle that can be recovered and curve-fitted with equation (5) to form the 2-dimentional distribution of the film thickness and the optic axis polar angle.

After understanding theory and principle of the present invention, two specimens with different 3-order thickness are used to show application and potential utility of the present invention. The first specimen is a thick LiNbO₃ single crystal with 1.1 mm thickness, and the second specimen is a thin liquid crystal cell with 4.9 μm thickness.

### The First Embodiment

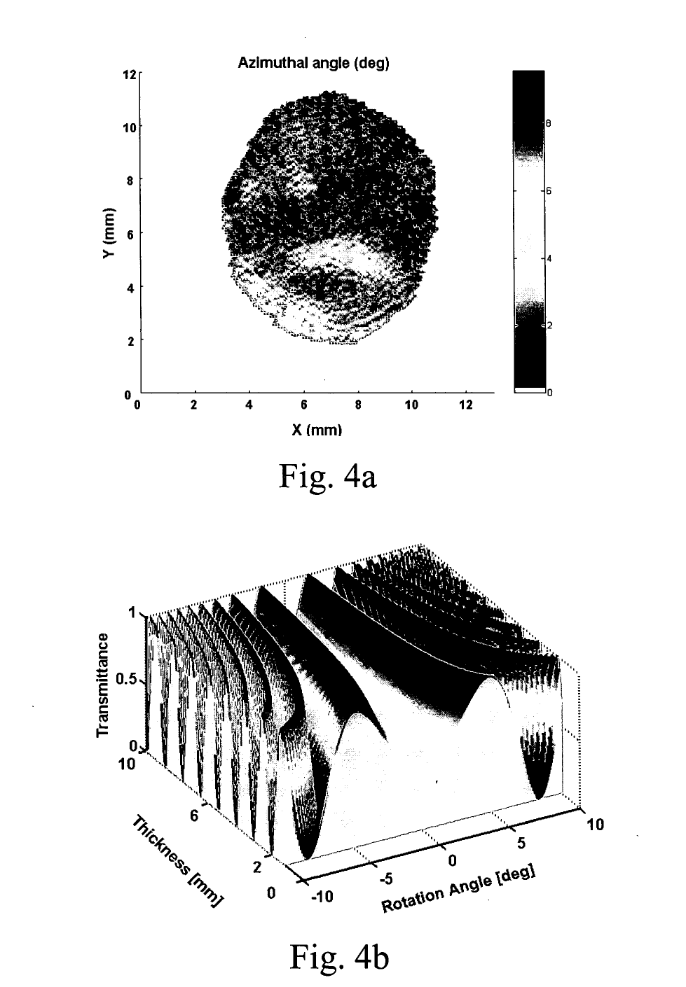

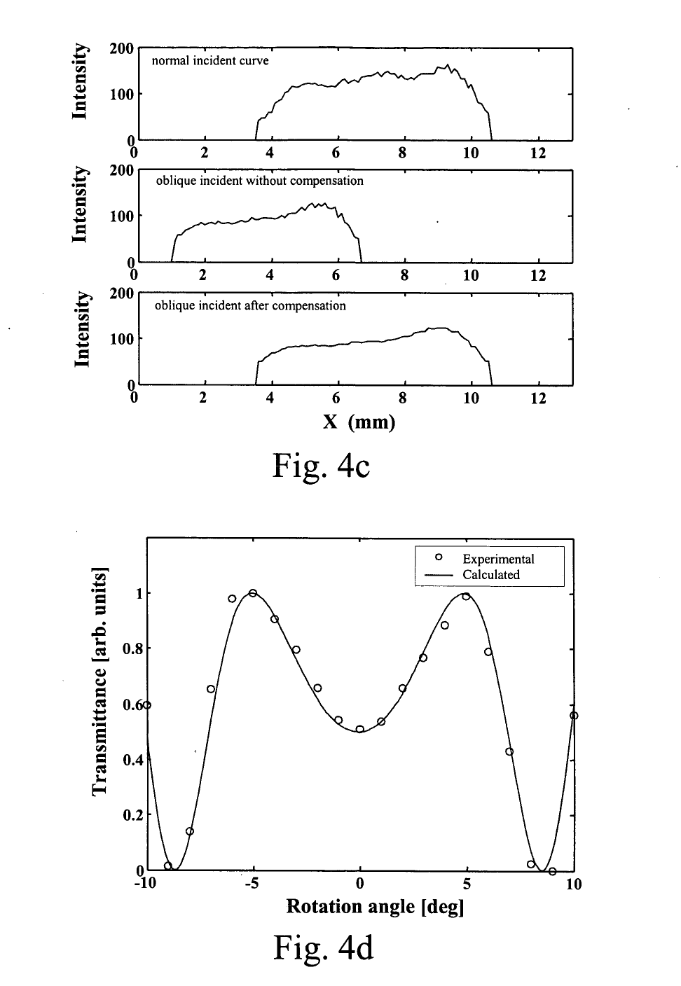

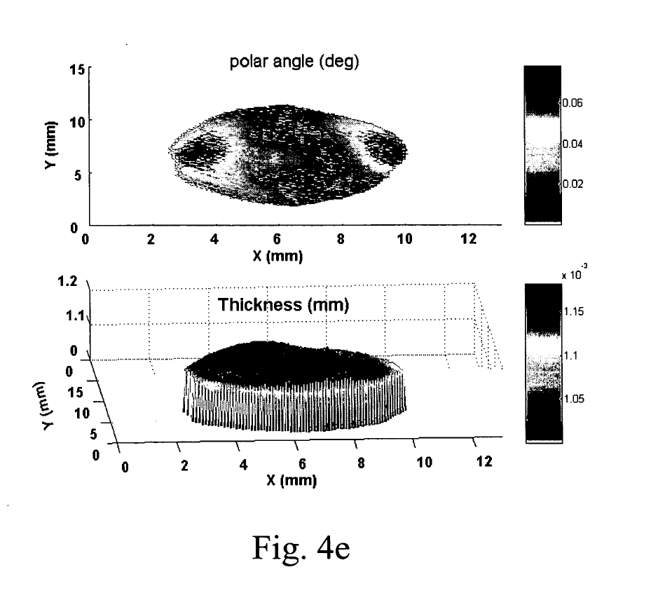

A LiNbO₃ single crystal specimen with 1.1 mm thickness is used with n₁=2.204 and n₂=2.296. The optic axis of this specimen is along the normal of the crystal and the pretilt angle α is 0°. Firstly, an advanced measurement is performed to verify the angle β. Since the optic axis is along z direction, the specimen is rotated an angle (about 4 degrees) to x direction with the y-axis as a rotating axis, and the analyzer is rotated to make the angle φ changing from 0° to 180°. 19 pictures can be obtained by taking pictures with the CCD every 10°. In the 19 pictures, 19 intensities corresponding to a same pixel is curve-fitted with equation (2), and the diagram of a sine function can be obtained to verify β=0°. FIG. 4a is a 2-dimentional distribution of the optic axis projecting angle β of the LiNbO₃ single crystal specimen.

Then, fixing the angle φ=π/4 and making sin 2(φ−β)=1 in equation (2). The specimen is rotated toward x direction with the y-axis as a rotating axis to change the angle ψ. FIG. 4b shows that when α=0° in equation (5), the thickness h changes from 1.1 mm to 10 mm, and the curve is calculated with the optical transmittance theory of ψ from −10 degrees to +10 degrees. This diagram is suggested to measure a specimen whose thickness is from 1 mm to 10 mm, and 21 pictures can be obtained by taking pictures with CCD every 1° from ψ=−10° to 10°.

In actual measurement, a slice with a 0.9 cm diameter circular hole is attached on the specimen to define the boundary of each diagram and find pixels whose intensity larger than the background light. At one time, for reducing the memory capacity, each diagram is averaged with 9 pixels (3×3) to obtain 21 diagrams with 160×213, and the size of the specimen in the diagram is about 10,000 pixels.

With the vertical incidence (ψ=0), the size projecting onto the CCD is the largest, and with larger the rotating angle ψ, the size projecting onto the CCD is getting smaller. The present invention uses the circular boundary ψ=0° as a standard, and reduces the minified diagram produced by other non-vertical incidence (ψ≠0°) with the linear interpolation, as FIG. 4c shows. The upper diagram is a 1-dimentional diagram, x-axis is the pixel position corresponding to the 1-dimentional cross section of the specimen, and y-axis is the light intensity. The middle diagram is a 1-dimentional cross section minified by rotating the crystal to ψ≠0°. The lower diagram is reduced from the ψ≠0° minified cross section with the linear interpolation and corresponding to the ψ=0° boundary, and the pixel shift effect caused by rotating the thick specimen can be removed. In the 21 pictures, the intensity variation corresponding to a same pixel is curve-fitting analyzed with two factors, thickness h and pretilt angle α, in equation (5). FIG. 4d shows the result of one pixel. After curve-fitting about 10,000 pixels, the 2-dimentional distribution of the thickness and the pretilt angle can be obtained, as shown in FIG. 4e.

The LiNbO₃ specimen is a stoichiometric LiNbO₃ produced by mixing the adaptive Li₂O, K₂O, and Nb₂O₃ in high-temperature and pulling with a seed. After excluding effect of the specimen thickness, the present measuring method can prove that the optic axis pretilt angle of this single crystal specimen is similar to the z-axis and the distribution of the crystal optic axis is very uniform (<0.04°). The shift degree of the optic axis at the boundary is little larger than that at the center, and it shows the effect of the seed position to the crystal growing.

### The Second Embodiment

For proving that the present invention is also suitable for the thin specimens, a liquid crystal cell with thickness 4.9 μm is used for thickness and optic axis measurement, and n₁=1.4756 and n₂=1.5586. When an alternating voltage with 1 kHz, +−4.6V is applied to the liquid crystal cell, the angle α of the liquid crystal molecule is about 49 degrees in theory. A pre-measurement is performed to get the angle β, and the angle β is also the rubbing direction of the liquid crystal cell. After obtaining the angle β, the rubbing direction of the liquid crystal cell is placed at x direction (β=0°), and makes φ=π/4 to obtain sin 2(φ−β)=1.

When α=50° in the equation (5), the thickness h changes from 4.9 μm to 25 (m, and FIG. 5a shows the optical transmittance of the angle (from −50 degrees to +50 degrees. This diagram suggests that when the thickness of the specimen is between 5 (m to 25 (m, (=−50(to 50(can be used every 5(to take pictures with the CCD. FIG. 5b is a cross section diagram of FIG. 5a at thickness 4.9 (m, and the green line is the retardation and the blue line is the optical transmittance of the light intensity. 21 pictures are obtained with the measuring method of this embodiment. Similarly, the minified diagram (□ EMBED Equation. 3 □□□0 (is reduced with the linear interpolation and two factor is curve-fitted, and the thickness h and the pretilt angle (of each position in the liquid crystal cell is obtained. FIG. 5c shows the result of the experiment data being curve-fitted. A 2-diemntional distribution of thickness and pretilt angle of the liquid crystal cell can be obtained after curve-fitting about 10,000 pixels, as shown in FIG. 5d.

This liquid crystal cell specimen has a 0.1 μm variation of the thickness, and this value is similar to the surface roughness of the ITO glass. The range of the pretilt angle of the liquid crystal molecule under 4.6V voltage is about 48-49 degrees, and matches the theory. This embodiment shows the present invention is also very useful for verifying the uniformity of the 2-dimentional surface while fabricating the liquid crystal devices.

Another clear embodiment is shown in FIG. 5e, which is a 2-dimentional distribution of the pretilt angle (upper) and the thickness (lower) of the liquid crystal spatial light modulator. With applying voltages 2.44V, 9.03V, and 1.22V (from left to right) at different positions of the liquid crystal spatial light modulator in advance, the liquid crystal tilt angles are individually α=53°, 20° and 82°, and the liquid crystal thickness of the liquid crystal spatial light modulator is 9.7 μm. This measurement result in the figure matches the actual situation, and that means the present invention is very reliable for measuring the thin specimen.

The present invention rotates the analyzer in advance to continuously change the azimuth of the analyzer and obtain the corresponding images. Then, the captured pictures evolve the azimuth patterns of each pixel, and evolve the 2-dimemtional distribution of the projected optic axis on the specimen plane. Next, the specimen is rotated to measure to position the direction of the film optic axis in the 3-dimentional space and the 2-dimentional distribution. Hence, the present invention can be applied to the industries of liquid crystal display, optical crystal inspection, scientific equipment, optical chip process control, optical measurement analysis, and medical inspection.

In contrast to the prior art, the present invention only uses a measurement structure to obtain both the thickness and the optic axis direction of optical crystals, so that the conventional disadvantages can be solved and the cost can be effectively lowered. In addition, the present invention not only provides an economic and convenient measuring method but also overcomes the drawback of factor limitation and reality loss of the conventional polarizing measurement system. The image compensation is preformed with the interpolation and the curve-fitting, and the images can be reduced to the original size. With correctly overlapping different images pixel-by-pixel, an accurate optical measurement value can be obtained.

Those skilled in the art will readily observe that numerous modifications and alterations of the device may be made while retaining the teachings of the invention. Accordingly, the above disclosure should be construed as limited only by the metes and bounds of the appended claims.

1. An imaginary polarizing measuring method for simultaneously measuring an optical crystal thickness and an optic axis direction with a same polarimetry system, the polarimetry system includes a polarizing apparatus, a specimen stage, a light analyzer and an image detecting apparatus, a specimen is located on the specimen stage, the measuring method comprising:
rotating the analyzer while a polarized light from the polarizing apparatus passing through the specimen to the analyzer, a plurality of images of a light intensity variation corresponding to different azimuth positions of the analyzer are obtained, and a projected optic axis direction that the optic axis of the specimen projecting on a specimen plane is decided according to fitting of the images; and
rotating the specimen for adjusting a incident angle of the polarized light for the specimen to obtain a plurality of different transmission intensities, and deciding an optic axis direction and a thickness of the specimen according to detected variation of the transmission intensities.

2. The imaginary polarizing measuring method of claim 1, wherein the projected optic axis direction is a direction that the optic axis projecting on the specimen plane.

3. The imaginary polarizing measuring method of claim 1, wherein the projected optic axis direction is a 2-dimentional distribution of angles that the optic axis projecting on the specimen plane.

4. The imaginary polarizing measuring method of claim 1, wherein a direction in 3-dimentional space and a 2-dimentional distribution in 3-dimentional space of the optic axis of the specimen can be further decided according to detected variation of the transmission intensities.

5. The imaginary polarizing measuring method of claim 1, wherein a 2-dimentional distribution of thickness of the specimen can be further decided according to detected variation of the transmission intensities.

6. The imaginary polarizing measuring method of claim 1, wherein the step of rotating the analyzer is rotating the analyzer for continuously changing azimuth with a plurality of angles, and capturing the image of the light intensity variation once with the image detecting apparatus every angle to obtain a series of the images.

7. The imaginary polarizing measuring method of claim 1, wherein the step of proceeding fitting of the images is proceeding a curve fitting of light intensity variation of the images corresponding to same pixel with three factors, intensity of incident light, retardation, and projection angle, and obtaining the projected optic axis direction.

8. The imaginary polarizing measuring method of claim 1, wherein the step of deciding the optic axis direction and the thickness of the specimen further comprises an image compensating process for compensating image shift and minification caused by the specimen rotating, the image compensating process reduces the minified image with a linear interpolation after obtaining the different transmission intensities.

9. The imaginary polarizing measuring method of claim 8, wherein the image compensation process further comprises a curve-fitting process that curve-fitting analyzing with two factors, thickness and optic axis pretilt angle, to proceed the light intensity variation on pixels, after reducing with the linear interpolation, and obtaining 2-dimentional distribution diagram of thickness and optic axis pretilt angle of the specimen after performing the curving-fitting process for a plurality of pixels.

10. The imaginary polarizing measuring method of claim 1, wherein the step of adjusting the incident angle of the polarized light is continuous adjustment, and a series of the images are captured according to every different incident angles.

11. The imaginary polarizing measuring method of claim 1, wherein rotation of the analyzer is controlled by a computer.

12. The imaginary polarizing measuring method of claim 1, wherein adjustment of the incident angle of the polarized light is controlled by a computer.

13. The imaginary polarizing measuring method of claim 1, wherein the polarized light is a round polarized light.
